(19) United States
(12) Patent Application Publication
(10) Pub. No.: US 2012/0023027 A1
(43) Pub. Date: Jan. 26, 2012

(54) AUTOMATED METHOD AND SYSTEM FOR PRINT HEAD WARRANTY VERIFICATION

(75) Inventors: Douglas F. SUNDQUIST, Webster, NY (US); Russell James Powers, Fairport, NY (US)

(73) Assignee: XEROX CORPORATION, Norwalk, CT (US)

(21) Appl. No.: 12/841,616

(22) Filed: Jul. 22, 2010

(51) Int. Cl. G06Q 10/00; G06F 17/30; H04L 9/00

(52) U.S. Cl. 705/302; 713/189; 707/803; 707/E17.01; 707/E17.044

(57) ABSTRACT

According to aspects of the embodiments, there is provided methods and systems for handling warranty services in a printing environment through use of an automatic process that writes all necessary warranty claim data into a log that be sent to a warranty service provider for print head replacement. The invention, in one embodiment, avoids the additional costs and time for sending a print head to the warranty service provider, and minimizes any administration efforts of the warranty service provider. The invention reduces print head warranty process validation time and makes the process more robust by tracking initial install date, current system date, and usage of the print head to ensure the print head has been used and maintained properly during the warranty period. The warranty data is stored in an encrypted field so that it cannot be changed. Further, the warranty service provider and authorized users can request a warranty claim receipt without the need to remove or idle the print head.

### BACKGROUND

This disclosure relates in general to controlling replaceable modules in a printing system, such as a digital printing apparatus. More specifically, the invention relates to a computerized method and system for handling warranty services in such a printing environment where the replaceable module provides an accessible unique identifier.

Many machines have replaceable sub-assemblies. These subassemblies may be arranged as unit called a cartridge, and if intended for replacement by the customer or machine owner, may be referred to as a customer replaceable unit (CRU). Examples of a CRU may include a printer cartridge, a toner cartridge, or a transfer assembly unit. It may be desirable for a CRU design to vary over the course of time due to manufacturing changes or to solve post-launch problems with either the machine, the CRU, or a CRU and machine interaction. It is known to provide the CRU with a monitoring device commonly referred to as a CRUM (Customer Replaceable Unit Monitor). A CRUM is typically a memory device, such as a ROM, EEPROM, SRAM, or other suitable non-volatile memory device, provided in or on the cartridge. Information identifying the CRU is written on the EEPROM during manufacture of the CRUM. For example, information identifying a CRU as a developer cartridge and identifying the type of carrier, developer, and transfer mechanism contained in the developer cartridge may be written in the memory contained in the CRUM. When a CRU containing such a CRUM is installed in a machine, the machine's control unit reads the identifying information stored in the CRUM.

It is also important to ensure that CRUs (Customer Replaceable Units) are not used beyond the useful life of the CRU. Using a CRU beyond its useful life may likewise have a detrimental effect on print quality and/or on machine components. In some instances, it is desirable to determine whether a machine, especially the CRU, is being operated in accordance to contractual obligations such as warranty or licenses. It is customary to send the CRU to a warranty service provider (WSP) responsible for the underlying system, or device or even the corresponding CRU or spare part for proof purposes concerning a valid warranty claim. The sending of the spare part adds to the overall costs and time for determination of whether a replacement is proper by the warranty service provider. Also, the sending of such parts further adds to the administration efforts of the warranty service provider, e.g., determining whether the subunit or spare part is under warranty, disposing of the subunit or spare part, and the like.

For the reasons stated above, and for other reasons stated below which will become apparent to those skilled in the art upon reading and understanding the present specification, there is a need in the art for verifying print head warranty claims.

### SUMMARY

The disclosure relates to a computerized method and system for handling warranty services in a printing environment through use of an automatic process that writes all necessary warranty claim data into a log that can be sent to a warranty service provider for print head replacement. The invention, in one embodiment, avoids the additional costs and time for sending a print head to the warranty service provider, and minimizes any administration efforts of the warranty service provider. The invention reduces print head warranty process validation time and makes the process more robust by tracking initial install date, current system date, and usage of the print head to ensure the print head has been used and maintained properly during the warranty period. The warranty data is stored in encrypted fields so that it cannot be changed. Further, the warranty service provider and authorized users can request a warranty claim receipt without the need to remove or idle the print head.

### BRIEF DESCRIPTION OF THE DRAWINGS

FIG. 1 is a simplified elevational view of a printing system with machine controller capable of implementing a warranty services related to at least one replaceable unit in accordance to an embodiment;

FIG. 2 is an exemplary block diagram of a controller and replaceable units having a memory structure in accordance to an embodiment;

FIG. 3 shows data in tabular format for at least one print head as maintained in a memory structure in accordance to an embodiment;

FIG. 4 is an illustration of a warranty service provider and printer system exchange sequence in accordance to an embodiment;

FIG. 5 is a flow chart of a method to handle warranty services related to at least one replaceable unit of a printer system in accordance to an embodiment; and

FIG. 6 is a flow chart of a method to handle a warranty validation certificate request in accordance to an embodiment.

### DETAILED DESCRIPTION

While the present invention will be described in connection with preferred embodiments thereof, it will be understood that it is not intended to limit the invention to that embodiment. On the contrary, it is intended to cover all alternatives, modifications and equivalents as may be included within the spirit and scope of the invention as defined by the appended claims.

In one aspect, the invention is directed to a computerized method and system for handling warranty services in a printing system environment with less time and resource efforts than the known approaches. The invention, in one embodiment, avoids the additional costs and time for sending a subunit or spare part to the warranty service provider (WSP), and minimizes any administration efforts of the warranty service provider. Solid Ink (SI) Print Heads are considered a consumable in the printing system. When the customer installs a print head, the system read & writes data to the print head memory usually a non-volatile memory. If the print head is defective within a specified period after install (warranty period), the customer needs to send the failed component back to the manufacturer or an intermediary such as a WSP, and the WSP has to determine if the print head is defective within the warranty period. Often the WSP has to get involved to validate that a part is defective within the warranty period.

In yet another aspect, the disclosed embodiment relate to a method to handle warranty services related to at least one replaceable unit of a printer system comprising creating a memory structure at each replaceable unit containing at least one of service data, usage data of the replaceable unit, time data, performance data, identification data, location data, and warranty data; acquiring and accumulating in the created memory structure for each replaceable unit time data, service data, usage data, and performance data; creating at the printer system a warranty claim data log file for each replaceable unit from data in the created memory structure; initiating delivery at the occurrence of a warranty condition the warranty claim data log file for the at least one replaceable unit to subscribers of the warranty claim data log file, wherein a subscriber comprises at least a warranty service provider. The subscriber can then initiate replacement of the at least one replaceable unit after warranty claim data validation.

Still further aspect, the disclosed method where a warranty condition is at least one of replacement of the replaceable unit during a warranty time period, failing a performance criterion, exceeding usage of the replaceable unit, and a defined warranty criterion.

Still further aspect, the disclosed method wherein the at least one replaceable unit is a print head.

In another further aspect, the disclosed method where the created file with the warranty claim data is delivered to the service provider in electronic form.

Still further aspect, the disclosed method where a format for the created file containing warranty claim data is selected from a group consisting of XML, HTML and ASCII text.

In one aspect, the disclosed method further comprising indicating to the user of the printer system that a print head lifetime has expired, thereby requiring that the print head be replaced.

Still further aspect, the disclosed method where the warranty data comprises a warranty period determined from a current printer system date and an install date of the at least one replaceable unit.

Still further aspect, the disclosed method where the warranty data and the created warranty claim data log file are encrypted.

Still further aspect, the disclosed method further comprising providing a warranty claim certificate from the created warranty claim data log file to a user of the printer system, wherein the warranty claim certificate includes a field for a partial warranty claim.

In yet another aspect, the disclosed embodiment relate to a network arrangement for handling warranty services related to a replaceable unit of a printing system comprising a network connecting a plurality of locations in the printing system; a replaceable unit at each of the locations connected to the network, each of the replaceable unit having a memory structure with data and warranty information; and a controller connected to the replaceable unit at each of the locations through the network, wherein the controller executes instructions to handle warranty services for each of the locations by: acquiring and accumulating at each of the memory structures data relating to at least one of time, service, usage, and performance for each replaceable unit; creating a warranty claim data log file for each of the replaceable unit from the acquired data and warranty information; delivering to a warranty service provider the created warranty claim data log file if a warranty condition is present for the replaceable unit; wherein the warranty service provider can initiate replacement of the at least one replaceable unit after warranty claim data validation.

In another aspect, the disclosed embodiment relate to a computer-accessible medium having executable instructions to handle warranty services related to at least one print head of a printer system, the executable instructions capable of directing a processor to perform creating a memory structure at each print head containing at least one of service data, usage data of the print head, time data, performance data, identification data, location data, and warranty data; acquiring and accumulating in the created memory structure for each print head time data, service data, usage data, and performance data; creating at the printer system a warranty claim data log file for each of print head from data in the created memory structure; and delivering to a warranty service provider the created warranty claim data log file if a warranty condition is present for the print head; wherein the warranty service provider can initiate replacement of the at least one print head after warranty claim data validation.

Embodiments as disclosed herein may also include computer-readable media for carrying or having computer-executable instructions or data structures stored thereon for operating such devices as controllers, sensors, and eletromechanical devices. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

In yet another aspect, the disclosed embodiment relate to a data retrieval system to handle warranty services for a print head of a digital printer, the data retrieval system comprising a memory structure containing at least one of service data field, usage data field, time data field, performance data field, identification data field, location data field, and warranty data field; monitoring unit to acquire and accumulate in the memory structure time data, service data, usage data, and performance data; and a logic unit to execute instructions to handle warranty services by creating a warranty claim data log file from data in the memory structure; initiating delivery of the warranty claim data log file on at least one of access request and replacing the print head.

The term “printing system” as used herein refers to a digital copier or printer, image printing machine, digital production press, image reproduction machine, bookmaking machine, facsimile machine, multi-function machine, or the like and can include several marking engines, feed mechanism, scanning assembly as well as other print media processing units, such as paper feeders, finishers, and the like.

As used herein, the term “controller area network” or “control area network” (CAN) is used to describe a control bus and associated control processor typically found in printer system.

As used herein, the term subscriber refers to a consumer of warranty data. The subscriber may elect to receive the warranty data as a physical copy or as an electronic copy through an access terminal having the appropriate hardware with which an access network communicates. An access terminal may be mobile or stationary. An access terminal may be any data device that communicates through a wireless channel or through a wired channel, for example using fiber optic or coaxial cables. An access terminal may further be any of a number of types of devices including but not limited to PC card, compact flash, external or internal modem, or wireless or wireline phone. An access terminal that is in the process of establishing an active traffic channel connection with an auxiliary processor (AP) is said to be in a connection setup state. An access terminal that has established an active traffic channel connection with an AP is called an active access terminal, and is said to be in a traffic state.

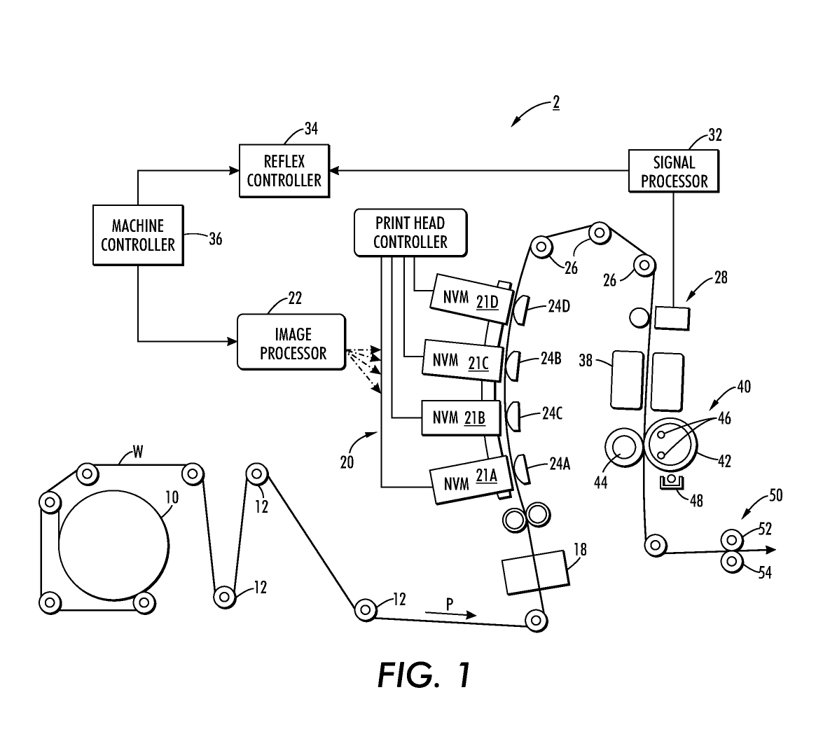

FIG. 1 is a simplified elevational view of a printing system with machine controller capable of implementing a warranty services related to at least one replaceable unit in accordance to an embodiment. The illustrated printing system is a direct-to-sheet, continuous-web, phase-change ink printer suitable for implementing aspects of the exemplary method. It is to be understood that other types of printers are contemplated. A very long (i.e., substantially continuous) web W of “substrate” (paper, plastic, or other printable material), supplied on a spool 10, is unwound as needed, propelled by a variety of motors (not shown). A set of rolls 12 controls the tension of the unwinding web Was it moves through a path. Along the path is a preheater 18, which brings the web W to an initial predetermined temperature. The preheater 18 can rely on contact, radiant, conductive, or convective heat to bring the web W to a target preheat temperature.

A printing system or copying machine may comprise replaceable CRU(s) such as a photoreceptor cartridge, a developer cartridge, a toner cartridge, an ink cartridge, print head, and print cartridge each of which is generally designed to function for a preset number of images in the form of prints or copies. The photoreceptor cartridge includes a photoreceptor drum. The developer cartridge includes a development system and receives a toner cartridge. The toner cartridge includes a sump for toner. The ink cartridge includes ink. The print cartridge may include at least one ink container fluidly connected to at least one print head. The print head ejects ink onto a print medium such as paper in controlled patterns of closely spaced dots. The print head may be sealingly attached to the ink container and the combined print head and container form a cartridge.

The web W moves through a printing station 20 including a series of marking stations or print heads 21A, 21B, 21C, and 21D, each print head effectively extending across the width of the web and being able to place ink of one primary color directly (i.e., without use of an intermediate or offset member) onto the moving web, and an image processor 22 that sends image data to each print head. The print head contains a memory 23 such as a non-volatile memory for storing usage, maintenance performed, and warranty data. As is generally familiar, each of the four primary-color images placed on overlapping areas on the web W combine to form a full-color image, based on the image data sent to each print head. There may be multiple print heads for each primary color; the print heads can each be formed into a single linear array; the function of each color print head can be divided among multiple distinct print heads located at different locations along the process direction; or the print heads or portions thereof can be mounted movably in a direction transverse to the process direction P, such as for spot-color applications. In larger printing environment there could be for example sixteen (16) banks each containing four print heads per bank. In such a printing system there would be a total of 84 print heads.

Associated with each primary color print head is a backing member 24A, 24B, 24C, 24D, typically in the form of a bar or roll, which is arranged substantially opposite the print head on the other side of web W. Each backing member is used to position the web W so that the gap between the print head and the sheet stays at a known, constant distance.

The ink directed to web W is typically a “phase-change ink,” that is, the ink is substantially solid at room temperature and substantially liquid when initially jetted onto the web W. Such inks are typically heated and thus in liquid phase, upon being jetted onto the web W. The liquid ink cools down upon hitting the web W. Other inks of interest are “UV inks,” which in addition to cooling are hardened by exposing the ink to ultra violet radiation. Whether the print heads are used regularly or not, they need to be purged and wiped, so that they do not clog and cause weak or missing jets. Intermittent weak or missing jets can have a negative impact on image quality. In an effort to correct image quality defects, customers may have the incentive to replace print heads more often than they need to be placed. This may cause a concern as to the expense with the customer.

As the partially-imaged web W moves to receive inks of various colors throughout the printing station 20 it is required that the temperature of the web be maintained to within a given range for maintaining image quality, in particular, maintaining constant ink lateral spread (i.e., across the width of web W, such as perpendicular to process direction P) and constant ink penetration of the web. However, since ink is jetted at a temperature typically significantly higher than the receiving web's temperature, the surrounding web will be heated. Therefore, temperature of the members in contact with or near the web W must be adjusted so that that the desired web temperature is maintained.

Depending on the thermal properties of the particular inks and the web W, this web temperature uniformity may be achieved by preheating the web with preheat unit 18 and using uncontrolled backer members, and/or by controlling the different backer members 24A, 24B, 24C, 24D to different temperatures to keep the substrate temperature substantially constant throughout the printing station. Temperature sensors (not shown) associated with the web W may be used with a control system to achieve this purpose, as well as systems for measuring or inferring (from the image data, for example) how much ink of a given primary color from a print head is being applied to the web W at a given time. The various backer members can be controlled individually, using input data from the print head adjacent thereto as well as from other print heads in the printing station.

Following the printing zone 20 along the web path is a series of tension rolls 26, an image sensing unit 28, a white baker roll 30, and a signal processing unit 32. The image sensing unit 28 may comprise any type of electronic sensor including a charge coupled device (CCD) array or a full width array (or imaging bar). A CCD or full width array typically comprises one or more linear arrays of photo-sites, wherein each linear array may be sensitive to one or more colors. In a color image capture device, the linear arrays of photo-sites are used to produce electrical signals which are converted to color image data representing the scanned document. However, in a black-and-white scanner, generally, only one linear array of photo-sites is used to produce the electrical signals that are converted to black and white image data representing the image of the scanned document.

Also shown is a midheater 38, which can use contact, radiant, conductive, and/or convective heat to bring the web W to the target temperature. The midheater 38 brings the ink placed on the web to a temperature suitable for desired properties when the ink on the web is sent through the spreader 40.

Following the midheater 38 along the path of web W is a “spreader” 40, which applies a predetermined pressure, and in some implementations, heat, to the web W. The function of the spreader 40 is to take what are essentially isolated droplets of ink on web W and smear them out to make a continuous layer by pressure, and, in one embodiment, heat, so that spaces between adjacent drops are filled and image solids become uniform. In addition to spreading the ink, the spreader 40 may also improve image permanence by increasing ink layer cohesion and/or increasing the ink-web adhesion. The spreader 40 includes rolls such as image-side roll 42 and pressure roll 44 that apply heat and pressure to the web W. Either roll can include heat elements such as 46 to bring the web W to a temperature in a range from about 35.degree. C. to about 80.degree. C.

The spreader 40 can also include a cleaning/oiling station 48 associated with image-side roll 42, suitable for cleaning and/or applying a layer of some lubricant or other material to the roll surface. The midheater 38 and the spreader 40 can be combined within a single unit, with their respective functions occurring relative to the same portion of web W simultaneously.

The printer shown further includes a “glosser” 50, whose function is to change the gloss of the image (such a glosser can be considered an “option” in a practical implementation). The glosser 50 applies a predetermined combination of temperature and pressure, to obtain a desired amount of gloss on the ink that has just been spread by spreader 40. Additionally, the glosser roll surface may have a texture that the user desires to impress on the ink surface. The glosser 50 includes two rolls (image-side roll 52 and pressure roll 54) forming a nip through which the web W passes.

In each of the spreader 40 and glosser 50, the image side roll 42 or 52 contacting the inked side of the web is typically reasonably hard, such as being made of anodized aluminum. Elastomeric or rubbery pressure rolls of one or more layers can be provided.

Detailed and independent control of the respective temperatures associated with spreader 40 and glosser 50 enables gloss adjustment given particular operating conditions and desired print attributes.

Following passage through the spreader 40 and glosser 50, the printed web can be imaged on the other side, and then cut into pages, such as for binding (not shown). Although printing on a substantially continuous web is shown in the embodiment, the embodiments can be applied to a cut-sheet system as well.

Images are formed on the web W as follows. The machine controller 36 sends information on images to be printed to the image processing unit 22. The machine controller 36 also sends web motion information to the double reflex controller 34. Based on the web motion information, the double reflex controller 34 generates timing signals for each print head as to when to jet inks. Details on double reflex controller function can be found, for example, in U.S. Pat. Pub. No. 2008/0124158 A1, the disclosure of which is hereby incorporated by reference in its entirety. The print head interface controller 25 (need to mark this in the figure) receives the timing signals from the double reflex controller 34 and also receives image data from the image processing unit 22 and operates nozzles in the print heads 21A, 21B, 21C, 21D to jet inks.

The image then moves along and passes under the image sensing unit 28. Sensing unit 28 need not be positioned after midheater 38 and can in fact be disposed anywhere along the web path. The sensing unit 28 captures a set of selected images and sends the captured image data to the signal processing unit 32. Any form of capturing device can be employed and limited only by the particular design. The signal processing unit 32 analyzes the data, quantifies misregistration, and sends adjustments to remove registration errors to the double reflex controller 34. Then, the controller 34 adjusts ink jet timings accordingly.

It should be noted that press 100, shown in FIG. 1, is merely an example of a system to which the present technology may be advantageously applied. The present technology is not limited to this system and in fact, contemplates application to and implementation in any type of system in which multiple replaceable unit exist. Additional non-limiting examples of systems to which the present technology may be applied include xerographic or other photocopiers, paper handlers, document finishers, scanners, printers, fax machines, and the like. In addition, one of skill in the art would recognize that the present technology is not limited to implementation with programmable devices. Although, for simplicity, this document uses the term programmable device, it is to be understood that the present technology may be implemented relative to any type of software or firmware based processor, such as microcontrollers, microprocessors, computer systems, and the like, and that the term programmable device encompasses any such software or firmware based processor.

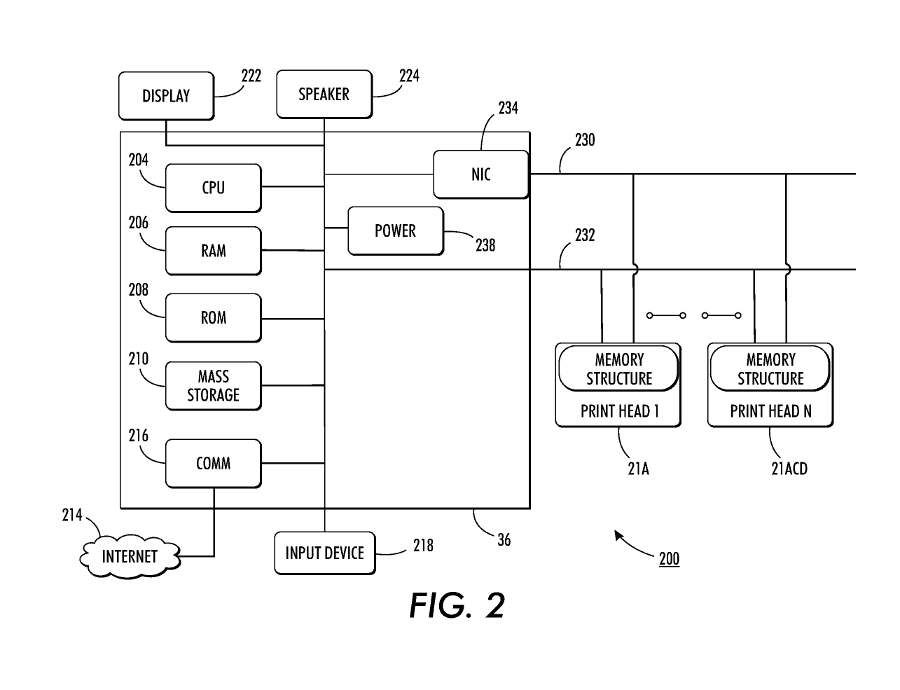

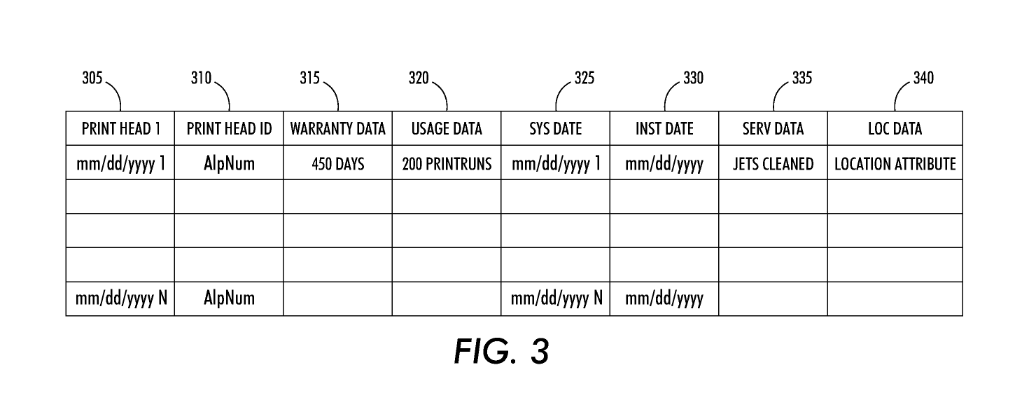

An example of a consumer replaceable unit monitoring 200 for monitoring CRUs such as print heads is shown in FIG. 2. Architecture 200 includes multiple CRUs, which may be arranged in groups, such as CRUs 21A-21ACD, or individually, such as CRU 21A and CRU 21ACD. Each CRU 21A-21ACD includes a memory device such as a customer replaceable unit monitor (CRUM) integral therewith. Each CRUM may include multiple memories of different types. To enable the CRUM to be electrically connected and disconnected with the printing system on installation or removal of the CRU, contact pads are provided. Terminal blocks and a terminal board may be used to complete the electrical connection between the CRUM and a machine controller of the printing system. Each CRU contains a memory structure created in a nonvolatile memory (NVM) with assigned fields and with assigned levels of protection as discussed in FIG. 3. Each CRUM contains processors, circuitry, or logic devices for monitoring and executing instructions that permit it to fully perform warranty services for other devices or subscribers such as printer system shown in FIG. 1, warranty service providers, users of the printer system, or any other authorized user that has a connection either directly or through a network to the CRUM. The CRUs are communicatively connected by a communication path which may include cabling or optical coupling. Communication path may also be a network, such as a standard wide area network (WAN) 232, or CAN-bus 230, and the like.

Various memory systems may be used in the CRUM including ROM, RAM, EEPROM, magnetic, or optical. Data relating to the CRU may be stored in a memory on the CRUM. For example, a preset number of total images for the CRU, various threshold(s) values of use for notice for the CRU, and various predetermined information to aid the user may be programmed into the CRUM by the manufacturer. The CRUM may include addressable memory for storing various information about the CRU such as installation date, warranty information, or fields that are determined from monitored fields like warranty period. The CRUM may have a number of programmed thresholds ranging from one to several hundred, although less than twenty thresholds, such as one to ten thresholds for the CRU are envisioned. The thresholds for the CRU may be set at various values. In addition, the CRUM may be updated, for example, with a count of events in which the CRU has functioned in by the print head controller 25 or machine controller 36 of the printing system at the end of each run. For example, each CRUM may be pre-programmed with total images value reflecting the maximum number of images that can be made using the CRU. The total images value may decline as each image is made to provide a current total image count value.

Predetermined information about the CRU from the CRUM may be provided in a printed document at the printing machine to aid the user or as an electronic file selected from a group consisting of XML, HTML, portable document format (PDF), email, and ASCII text may be provided to the user or other parties such as a warranty provider. For example, the predetermined information about the CRU may relate to obtaining, ordering, using, servicing, warranty, removing, installing, recycling, or combinations thereof. The system is intended to provide sufficient notice of the demise of the CRU at various intervals of use and to allow the user or warranty providers sufficient time, for example, about two weeks to initiate a replacement CRU using the information readily provided in the printed document such as an electronic file. The predetermined information allows the parties to solve a problem with respect to the CRU during the life of the CRU. In addition, an electronic e-mail message may be sent to the user, to a User Interface (UI) such as a graphical user interface, or to a display window to supplement the printed document or electronic document. A notice based on the remaining images with respect to the CRU may be provided at selected intervals or at selected thresholds based on, for example: a percentage of life remaining in the CRU, ranging from 100% to 0%; a number of images remaining for the CRU to function, ranging from about fifty thousand remaining images to one remaining image; and a number of weeks for the CRU to function, ranging from about sixteen weeks to about one week, depending on the users anticipated or average monthly image volume. The file may contain information for ordering a replacement CRU including identification number and contact information including vendors, manufacturers, or third parties including their respective address, phone number, facsimile number, e-mail address, Uniform Resource Locator (URL) address, and combinations thereof.

The description of FIG. 2 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

Machine controller 36 includes a processor 204, commercially available from Intel, Motorola, Cyrix and others. Machine controller 36 also includes random-access memory (RAM) 206, read-only memory (ROM) 208, and one or more mass storage devices 210, and a system bus 212, that operatively couples various system components to the processing unit 204. The memory 206, 208, and mass storage devices, 210, are types of computer-accessible media. Mass storage devices 210 are more specifically types of nonvolatile computer-accessible media and can include one or more hard disk drives, floppy disk drives, optical disk drives, and tape cartridge drives. The processor 204 executes computer programs stored on the computer-accessible media.

Machine controller 36 can be communicatively connected to the Internet 214 via a communication device 216. Internet 214 connectivity is well known within the art. In one embodiment, a communication device 216 is a modem that responds to communication drivers to connect to the Internet via what is known in the art as a “dial-up connection”. In another embodiment, a communication device 216 is an Ethernet® or similar hardware network card connected to a local-area network (LAN) that itself is connected to the Internet via what is known in the art as a “direct connection” (e.g., T1 line, broadband, and the like).

A user enters commands and information into the machine controller 36 through input devices such as a keyboard 218 or a pointing device 220. The input device 218 such as a keyboard permits entry of textual information into computer 36, as known within the art, and embodiments are not limited to any particular type of keyboard. A Pointing device (not shown) permits the control of the screen pointer provided by a graphical user interface (GUI) of operating systems such as versions of Microsoft Windows®. Embodiments are not limited to any particular pointing device 220. Such pointing devices include mice, touch pads, trackballs, remote controls and point sticks. Other input devices (not shown) can include a microphone, joystick, game pad, satellite dish, scanner, or the like.

In some embodiments, machine controller 36 is operatively coupled to a display device 222. Display device 222 is connected to the system bus 212. Display device 222 permits the display of information, including computer, video and other information, for viewing by a user of the computer. Embodiments are not limited to any particular display device 222. Such display devices include cathode ray tube (CRT) displays (monitors), as well as flat panel displays such as liquid crystal displays (LCD's). In addition to a monitor, computers typically include other peripheral input/output devices such as printers (not shown). Speakers 224 and 226 provide audio output of signals. A speaker is also connected to the system bus 212.

Machine controller 36 also includes an operating system (not shown) that is stored on the computer-accessible media RAM 206, ROM 208, and mass storage device 210, and is executed by the processor 204. Examples of operating systems include Microsoft Windows®, Apple MacOS®, Linux®, UNIX®. Examples are not limited to any particular operating system, however, and the construction and use of such operating systems are well known within the art.

Embodiments of machine controller 36 are not limited to any type of computer. In varying embodiments, machine controller 36 comprises a PC-compatible computer, a MacOS®-compatible computer, a Linux®-compatible computer, or a UNIX®-compatible computer. The construction and operation of such computers are well known within the art.

Machine controller 36 can be operated using at least one operating system to provide a graphical user interface (GUI) including a user-controllable pointer. Machine controller 36 can have at least one web browser application program executing within at least one operating system, to permit users of machine controller 36 to access an intranet, extranet or Internet world-wide-web pages as addressed by Universal Resource Locator (URL) addresses. Examples of browser application programs include Netscape Navigator® and Microsoft Internet Explorer®.

The machine controller 36 can operate in a networked environment using logical connections to one or more remote devices, such as CRUs 21A & 21ACD. These logical connections are achieved by a communication device coupled to, or a part of, the machine controller 36. Embodiments are not limited to a particular type of communications device. The logical connections depicted in FIG. 2 include a local-area network (LAN) and a wide-area network (WAN) 232. Such networking environments are commonplace in offices, enterprise-wide computer networks, intranets, extranets and the Internet.

When used in a LAN-networking environment, the Machine controller 36 and modules are connected to the local network through network interfaces or adapters 234, which is one type of communications device 216. Remote computer 228 also includes a network device 236. When used in a conventional WAN-networking environment, the computer 36 and remote computer 228 communicate with a WAN 232 through modems (not shown). The modem, which can be internal or external, is connected to the system bus 212. In a networked environment, program modules depicted relative to the machine controller 36, or portions thereof, can be stored in the remote computer 228. Machine controller 36 also includes power supply 238. Each power supply can be a battery.

FIG. 3 shows data in tabular format for at least one print head as maintained in a memory structure in accordance to an embodiment. Example of the data that is monitored by the system and maintained in the memory structure are as follows:

Fields for Data Table (NVRAM) for Each Print Head

| | //*** NVRAM |
|---|---|
| //*** NVRAM CONTENTS *** | CONTENTS *** |
| //Format | //STD Mode Wave |
| | Values |
| //PageCount | //waveType |
| //EXE | //Xres |
| //INI | //Yres |
| //SN | //NORM |
| //calDate | //NORM |
| //DriverType | //NORM |
| //HeadVersion | //NORM |
| //Ink Type | //SetPoints |
| //JS Channels | //jetFreq |
| //Res Channels | //Y_NORMTYPE |
| //JS Jet 1 Row | //Y_ROW_INFO |
| //Within Color Row Offset | //Y_ROW_DELAYS |
| //Ink Level Sense Type | //Y_JET_DIVISOR |
| //Ink Thresh | //Y_NORM |
| //NX Ink Thresh | //Y_NORM |
| //Ink Res Temp Thresh | //Y_NORM |
| //Ink Res Temp Overdrive | //Y_NORM |
| //Standby1 SP | //waveID |
| //Standby2 SP | //x(Timing in uS) |
| //Purge Ready SP | //y(Voltage in V) |
| //DCStandby1 | //drive |
| //DCStandby2 | //connect |
| //Control Loop Type | //scale |
| //CONTROL LOOP PARAMS | //reference |
| //Reservoir | //pulseNum |
| //Left JS | //NORM SEGMENT |
| //Right JS | //SEGMENT 1 |
| //OTHER THERMALS | //SEGMENT 2 |
| // | //SEGMENT 3 |
| //JS POWER CONTROL | //maxVoltage |
| //JS MAX PWR KNEE SP | //maxNormValue |
| //JS Initial/Final PWR Limits % | //DropMass |
| //RES Segments | //driftCompensationType |
| //RES MAX PWR KNEE SP | //DCTimeFactor |
| //RES CHANNEL/PWR/VOLTS/ | //DCTimeStart |
| INITIAL LIMIT/FINAL LIMIT | |
| //1 | //DCSlope |
| //annexVersion | //DCMaxDeltaV |
| //skipCount | //equationCount |
| //AnnexData | //RowNumber |
| //waveCnt | //0 |
| //purgeWave | //1 |
| //jetCount | //14 |
| //rowCount | //15 |
| //Y_ROW_GEOMETRY_OFFSET | //YDPMaxDeltaV |
| (ucrons) | |
| //X_ROW_GEOMETRY_OFFSET(ucrons) | //DMTimeFactor |
| //drumDiameter | //DMTimeStart |
| //headPosition | //DMSlope |
| //printerFlags | |
| Warranty start Date | |
| //DMMaxDeltaV | //Y_NORM |
| //cMatchTarget | //Y_NORM |
| //cMatchSensitivity | //Y_NORM |
| //dropMassUpperDelta | //FAST Mode Wave |
| | Values |
| //dropMassLowerDelta | //waveType |
| //dropMassBucket00 | //Xres |
| //dropMassBucket01 | //Yres |
| //dropMassBucket10 | //waveSource |
| //ENH Mode Wave Values | //Y_NORMTYPE |
| //waveType | //Y_ROW_INFO |
| //Xres | //Y_ROW_DELAYS |
| //Yres | //Y_JET_DIVISOR |
| //waveSource | //Y_NORM |
| //Y_NORMTYPE | //Y_NORM |
| //Y_ROW_INFO | //Y_NORM |
| //Y_ROW_DELAYS | //Y_NORM |
| //Y_JET_DIVISOR | |
| //Y_NORM | |

While the memory structure maintains data about diverse aspects of the print heads such as voltage and power consumption for the purposes of warranty services a limited group of data is necessary. The group of fields needed from the table depends on the desired granularity and the scope of the warranty. For example, a warranty can be based on a condition such as a failure occurring within an agreed upon time period. A warranty can also be based on purchased or installation date and an agreed upon date in the future based on some arbitrary start period. The warranty could be tailored on the buyer, user, or owner performing certain maintenance procedures or not exceeding an agreed upon number of copies. Table 300 shows fields for print head number 305, print head identification 310 such as an alphanumeric sequence, warranty data 315 that can be calculated from other fields on the table or a combination thereof, usage data 320 tracks total time and usage of each solid ink print head, system date 325 is the current date for the printing system, installation date 330 is the date when the print head was installed, service data 335 is the procedures performed on the print head such as cleaning and purging, and location data 340 indicated where the printing system is located. All these fields are used by the executable instruction acting through a processor to manage warranty services. Executable instructions (EI) directs a processor such as CPU 204 of machine controller 36 to track total time and usage of each Solid ink print head installed in the printer system which is essentially using the memory on the print head 21A-21ACD to act as a CRUM. The EI insures that the print heads have been properly cleaned and purged while the printer system is powered on. EI also insures that the warranty period for the print heads is stored in an encrypted field in the memory structure such as NVM so that it cannot be changed.

The EI through the processor and appropriate interfaces informs the user when a print head is under warranty and needs to be replaced. The EI contains software modules and uses encryption so that it is robust enough against being pirated or cheated. The EI tracks the location and the serial numbers or MAC address of the machine where the print head is installed. Performance criteria are table driven, allowing for easy updates in the fields for such data on density of missing jets, and threshold levels. Another advantage of using a table is that it allows for a pro-rated capability to compensate for a partial warranty claims if the strategy is adopted as a business strategy. The EI automatically prompts the user if they want a warranty claim receipt printed after they have replaced a failed print head. The EI also writes all necessary warranty claim data into a log file, and that log file is sent back to warranty service provider (WSP) thru Remote Services such as the internet. The log is then interpreted by the supplies organization at the WSP and the customer is automatically sent a new print head, based on the validated warranty information in the log file. This alleviates the need for the return of the print head, or a printed warranty receipt, or someone from the warranty service provider, having to try to validate the warranty claim in person thus eliminating costs in labor, travel, and down time of the printing system.

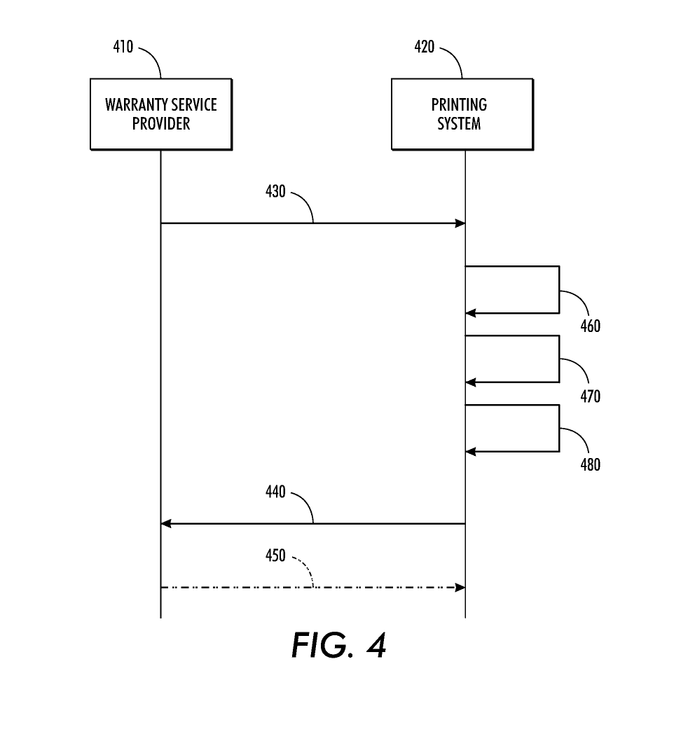

FIG. 4 is an illustration of a warranty service provider and printer system exchange sequence 400 in accordance to an embodiment. The exchange begins with a subscriber that may include a warranty service provider 410 such as merchant or manufacturer. The subscriber sends a request 430 for a warranty certificate to a printing system 420 having at least one replaceable unit such as a print head. At the printing system 420 the executable instructions (EI) acts on a processor to retrieve 460 data from the memory structure so that the processor can create or assemble 470 a warranty claim data log file. The warranty claim log data is then converted 480 to the appropriate file type such as formats from a group consisting of XML, HTML, ASCII text, binary file, SVG file, or user defined file type. The warranty claim data log file is then delivered 440 to the subscriber such as warranty service provider 410 for further processing. The warranty service provider initiates replacement of the print head as shown by arrow 450. The warranty claim data log file or warranty certificate is delivered to the warranty service provider by use of various communication schemes and various formats such as a physical copy through a facsimile device and an electronic mail (email) attachment via a network or the like. Instead of using a printout so as to expedite and automate, the certificate is delivered to the warranty service provider in an electronic format such as an e-mail or PDF document. On the other hand, a printed form of the certificate can be delivered also using common post mail delivery services or the like. It is important to note that regardless of the method of delivery the executable instruction is able to determine a warranty claim for the subscriber of the warranty data. The warranty service provider is not involved, nor is anyone else making the decision to determine if the print head should be warranted. The printing system is capable of determining automatically from the stored data whether the criteria have been met for a warranty claim. While FIG. 4 is illustrating a request from a warranty service provider the same sequence can be employed to fulfill the request of the user at the printing system or business logic that can request or automatically send the warranty certificate to the subscriber based on the occurrence of a warranty condition such as replacing the replaceable unit during a warranty time period, failing a performance criterion, exceeding usage of the replaceable unit, and a defined warranty criterion such as adding a new print head after so many print runs A warranty criterion can include image quality and other defined fields based on monitored data.

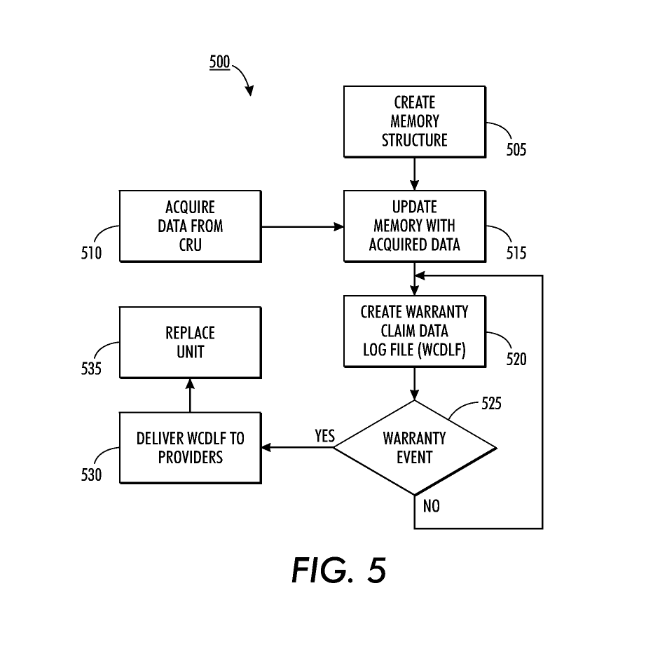

FIG. 5 is a flow chart of a method 500 to handle warranty services related to at least one replaceable unit of a printer system in accordance to an embodiment. Method 500 begins with action 505 where a memory structure is created. Action 505 creates a memory structure that includes the fields outlined in FIG. 3 and other fields as enumerate above with reference to FIG. 3. Control passes to action 510 where data from the customer replaceable unit (CRU) is acquired for processing and storing. In action 510 data relating to usage, system date, warranty, service, and location is acquired from each print head. Control then passes to action 515. In action 515, the data acquired in action 510 is stored in the created memory structure. Control passes to action 520. In action 520, the created memory structure is accessed to read the pertinent data such as warranty data and system date to create a warranty claim data log file (WCDLF). The WCDLF is file that identifies the print head, warranty information, information such time remaining on the life of the print head to compensate for a partial warranty claim, usage information, service information, and other information as required or agreed upon by the warranty service provider and the operator of the printing system or print head. Control passes to action 525 where a decision is made based on the occurrence of a warranty event. If a warranty event is not present then control goes to action 520 for creating another or updating the WCDLF file. In the case of a warranty condition then control passes to action 530 where the WCDLF is delivered to the warranty service provider for fulfillment of the warranty certificate. While action 530 shows delivery to a warranty service provider it should be understood that other subscribers of the information could be included as recipient of the information such as the user, owner, manufacturer, and service providers of the printer system. In action 535, the warranty service provider which is includes the manufacturer or third party inspects the created log file and is able to pay, or ship a replacement unit. In this case the log is interpreted by the supplies organization such as the WSP, and the customer is automatically sent a new print head, based on the information in the log file. This alleviates the need for the return of the print head or a printed warranty receipt.

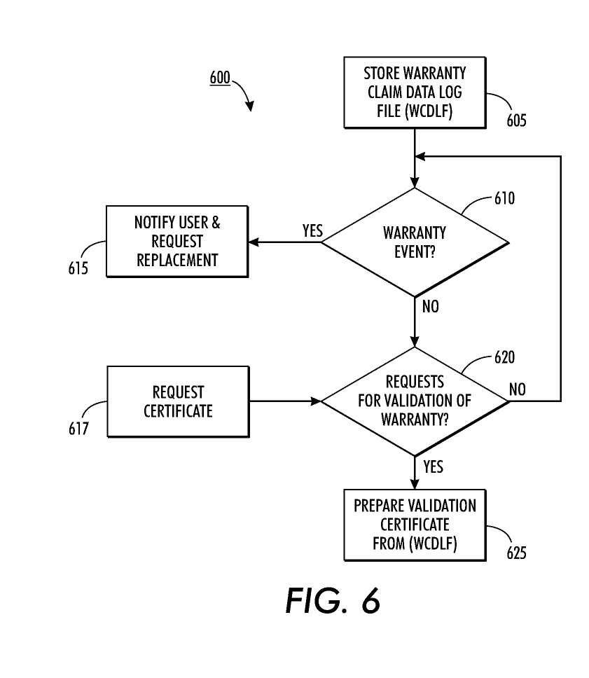

FIG. 6 is a flow chart of a method to handle a warranty validation certificate request in accordance to an embodiment. Method 600 begins with the storing of the warranty claim data log file in action 605. If a warranty event is detected at action 610, a user is notified and a replacement is requested in action 615. If a warranty event is not detected in action 610 control is then pass to action 620 to determine if a request for validation of warranty has been received at action 620. As shown, a request is received at action 617 from either an internal device such as input device 218 or from an external device received through a network device. The external device could located or under the command of the warranty service provider. If a request for validation is determined in action 620 control is passed to action 625 where the system prepares a warranty validation certificate from the log file in the form and format desired by the requester at action 617. If request id not present at action 620 control is passed to action 610 for further processing.

The request may include various notices based on the data stored in the memory structure or CRUM including combinations of information are envisioned. The notice may include information relating to ordering, returning, using, or installing the CRU. The notice may include information for a specific customer. The notice may include information for a geographic market in which the manufacturer has directed the CRU to be destined. The notice may include information for a specific configuration of the CRU. The notice may include information about the manufacturer. The notice may include information about a future disablement of the printing system and warranty modifications. The notice may include information in the form of a log of previously printed documents concerning the CRU. The notice may include information relating to a return address for recycling of the CRU. The notice may be in the form of a return label for recycling the CRU. The notice may include information relating to average print area coverage and average print rate for the CRU. The notice may include information relating to a total of the number of prints made using the CRU. The notice may include information relating to warranty information for the CRU. The notice may include information relating to notification of the CRU being used beyond its warranted life. The notice may include information relating to an estimate of the remaining life of the CRU. The notice may include information relating to a percentage of use of at least one of cyan (C) toner, magenta (M) toner, yellow (Y) toner, and black (K) toner in the CRU. The notice may include information relating to the date of manufacture of the CRU. The notice may include information relating to the place of manufacture of the CRU. The notice may include information relating to a replacement instruction of the CRU.

Although specific embodiments of the present technology have been described, it will be understood by those of skill in the art that there are other embodiments that are equivalent to the described embodiments. Accordingly, it is to be understood that the technology is not to be limited by the specific illustrated embodiments, but only by the scope of the appended claims.

What is claimed is:

1. A method to handle warranty services related to at least one replaceable unit of a printer system, the method comprising:
creating a memory structure at each replaceable unit containing at least one of service data field, usage data field, time data field, performance data field, identification data field, location data field, and warranty data field;
acquiring for each replaceable unit and accumulating in the created memory structure time data, service data, usage data, and performance data;
creating at the printer system a warranty claim data log file for each replaceable unit from data in the created memory structure; and
initiating delivery at the occurrence of a warranty condition the warranty claim data log file for the at least one replaceable unit to subscribers of the warranty claim data log file, wherein a subscriber comprises at least a warranty service provider.

2. The method according to claim 1, wherein a warranty condition is at least one of replacement of the replaceable unit during a warranty time period, failing a performance criterion, exceeding usage of the replaceable unit, and a defined warranty criterion.

3. The method according to claim 2, wherein the at least one replaceable unit is a print head.

4. The method according to claim 3, wherein the created file with the warranty claim data is delivered to the service provider in electronic form.

5. The method according to claim 4, wherein a format for the created file containing warranty claim data is selected from a group consisting of XML, HTML, ASCII text, binary file, SVG file, or user defined file.

6. The method according to claim 3, further comprising:
indicating to the user of the printer system that a print head lifetime has expired, thereby requiring that the print head be replaced.

7. The method according to claim 2, wherein the warranty data comprises a warranty period determined from a current printer system date and an install date of the at least one replaceable unit.

8. The method according to claim 7, wherein the warranty data and the created warranty claim data log file are encrypted.

9. The method according to claim 8, further comprising:
providing a warranty claim certificate from the created warranty claim data log file to a user of the printer system, wherein the warranty claim certificate includes a field for a partial warranty claim.

10. A network arrangement for handling warranty services related to a replaceable unit of a printing system comprising:
a network connecting a plurality of locations in the printing system;
a replaceable unit at each of the locations connected to the network, each of the replaceable unit having a memory structure with data and warranty information; and
a controller connected to the replaceable unit at each of the locations through the network, wherein the controller executes instructions to handle warranty services for each of the locations by:
acquiring and accumulating at each of the memory structures data relating to at least one of time, service, usage, and performance for each replaceable unit;
creating a warranty claim data log file for each of the replaceable unit from the acquired data and warranty information;
delivering to subscribers the created warranty claim data log file if a warranty condition is present for the replaceable unit, wherein a subscriber comprises at least a warranty service provider;
wherein the warranty service provider can initiate replacement of the at least one replaceable unit after warranty claim data validation.

11. The network arrangement of claim 10, wherein a warranty condition is at least one of replacement of the replaceable unit during a warranty time period, failing a performance criterion, exceeding usage of the replaceable unit, and a defined warranty criterion.

12. The network arrangement of claim 11, wherein the at least one replaceable unit is a print head.

13. The network arrangement of claim 12, wherein the created file with the warranty claim data is delivered to the service provider in electronic form.

14. The network arrangement of claim 13, wherein a format for the created file containing warranty claim data is selected from a group consisting of XML, HTML, ASCII text, binary file, SVG file, or user defined file.

15. The network arrangement of claim 12, further comprising the controller executing instructions to indicate to the user of the printing system that a print head lifetime has expired, thereby requiring that the print head be replaced.

16. The network arrangement of claim 11, wherein the warranty data comprises a warranty period determined from a current printer system date and an install date of the at least one replaceable unit.

17. The network arrangement of claim 16, wherein the warranty data and the created warranty claim data log file are encrypted.

18. The network arrangement of claim 17, further comprising:
providing a warranty claim certificate from the created warranty claim data log file to a user of the printer system, wherein the warranty claim certificate includes a field for a partial warranty claim.

19. A computer-accessible medium having executable instructions to handle warranty services related to at least one print head of a printer system, the executable instructions capable of directing a processor to perform:
creating a memory structure at each print head containing at least one of service data, usage data of the print head, time data, performance data, identification data, location data, and warranty data;
acquiring and accumulating in the created memory structure for each print head time data, service data, usage data, and performance data;
creating at the printer system a warranty claim data log file for each of print head from data in the created memory structure; and
initiating delivery to subscribers the created warranty claim data log file if a warranty condition is present for the print head, wherein a subscriber comprises a warranty service provider.

20. The computer-accessible medium of claim 19, the executable instructions capable of directing a processor to further perform:
indicating to the user of the printer system that a print head lifetime has expired, thereby requiring that the print head be replaced; and
providing a warranty claim certificate from the created warranty claim data log file to a user of the printer system, wherein the warranty claim certificate includes a field for a partial warranty claim;
wherein a warranty condition is at least one of replacement of the print head during a warranty time period, failing a performance criterion, exceeding usage of the print head, and a defined warranty criterion;
wherein the warranty data comprises a warranty period determined from a current printer system date and an install date of the at least one print head;
wherein the warranty data and the created warranty claim data log file are encrypted;
wherein the warranty service provider can initiate replacement of the at least one print head after warranty claim data validation.

21. A data retrieval system to handle warranty services for a print head of a digital printer, the data retrieval system comprising:
a memory structure containing at least one of service data field, usage data field, time data field, performance data field, identification data field, location data field, and warranty data field;
monitoring unit to acquire and accumulate in the memory structure time data, service data, usage data, and performance data; and
a logic unit to execute instructions to handle warranty services by:
creating a warranty claim data log file from data in the memory structure;
initiating delivery of the warranty claim data log file on at least one of access request and replacement of the print head.

22. The data retrieval system of claim 21, wherein the warranty claim data log file is delivered to at least one of digital printer, a warranty service provider, or authorized user having access to the digital printer.

23. The data retrieval system according to claim 21, wherein a format for the created file containing warranty claim data is selected from a group consisting of XML, HTML, ASCII text, binary file, SVG file, or user defined file.

24. The data retrieval system according to claim 23, further comprising:
indicating to the user of the printer system that a print head lifetime has expired, thereby requiring that the print head be replaced.

25. The data retrieval system according to claim 22, wherein the warranty data comprises a warranty period determined from a current printer system date and an install date of the at least one replaceable unit.

26. The data retrieval system according to claim 22, wherein the warranty data and the created warranty claim data log file are encrypted.
